(19) United States
(12) Patent Application Publication
(10) Pub. No.: US 2016/0313880 A1
(43) Pub. Date: Oct. 27, 2016

(54) PERSISTENT TRACKING OF A WORK SPACE ARRANGEMENT OF A CRM APPLICATION THROUGH A WEB BROWSER

(71) Applicant: SugarCRM Inc., Cupertino, CA (US)

(72) Inventors: Charles Godewyn, Phoeinix, AZ (US); Henry Rogers, Raleigh, NC (US)

(21) Appl. No.: 14/693,861

(22) Filed: Apr. 22, 2015

(51) Int. Cl. G06F 3/0483; G06F 3/0482; G06Q 30/00; G06F 3/0484

(52) U.S. Cl. CPC G06F 3/0483; G06F 3/04847; G06F 3/04842; G06F 3/0482; G06Q 30/01

(57) ABSTRACT

Embodiments of the invention provide for persistently tracking a work space arrangement of a CRM application through a Web browser. In an embodiment of the invention, a method for persistently tracking work space arrangement of a CRM application through a Web browser includes identifying different Web browser windows and tabs spawned in the Web browser connection with an end user interacting with a CRM application through the Web browser in an initial Web browser session. The method also includes storing a record of an arrangement of the identified Web browser windows and tabs in connection with the end user in connection with the CRM application. Finally, the method includes subsequently detecting the end user establishing a new Web browser session with the CRM application and automatically spawning the different Web browser windows and tabs stored in the arrangement specified in the record for the end user.

### BACKGROUND OF THE INVENTION

1. Field of the Invention

The present invention relates to user interface organization definition and more particularly to the storage of multiple user interface work place states for restoration on application start up or by user selection.

2. Description of the Related Art

Simple computer programs provide for a basic user interface through which all end user interactions occur. More complex multi-module computer programs are accessed through different displays presented contemporaneously with the accessing of a corresponding one of the modules. The advent of windowed operating systems permits even more complex user interface arrangements in which multiple different windows of a work space for a computer program can be presented concurrently side by side in a tiled mode, or overlapping one another in an ad hoc arrangement. To accommodate the customary utilization habits of different end users, multi-windowed computer programs in many cases provide for the memorization of a particular arrangement of windows for an application and the recall of the particular arrangement at startup of the application.

Web driven applications have revolutionized the way in which applications are developed, distributed and maintained. Prior to Web driven applications, the user interface for a computer program would have been statically defined at the time of development and dependent upon the visual display capabilities of an underlying operating system supporting the execution of the computer program. In a Web driven application, however, the user interface essentially is a collection of Web pages and display windows of a Web browser. The content and arrangement of each component in each Web page and display window, therefore, can change at any time merely by redefining any given Web page at the Web server serving the Web page for the Web driven application.

Of note, the convenience of the Web driven application is not without its drawbacks. In this regard, whereas in a conventional computer program the personalized selection and arrangement of program windows can be recalled at each startup the same is not true of a Web driven application. It is true that the modern Web browser allows the recall of a single Web application “page”, for instance the “home page” of the single Web application, during the startup of the Web browser through the memorization of that page's uniform resource locator (URL). However, in many data intensive Web applications there is no way to preserve the user's “state” of the open application as a URL. Further, tabbed Web browsers allow for the personalized recall of multiple different tabs at startup. However, the application work space presented through the Web browser itself enjoys little control over the personalized presentation of its different tabs and display windows.

### BRIEF SUMMARY OF THE INVENTION

Embodiments of the present invention address deficiencies of the art in respect to the arrangement of an application work place in a Web driven application and provide a novel and non-obvious method, system and computer program product for persistently tracking a work space arrangement of a CRM application through a Web browser. In an embodiment of the invention, a method for persistently tracking work space arrangement of a CRM application through a Web browser includes identifying different Web browser windows and tabs spawned in the Web browser connection with an end user interacting with a CRM application through the Web browser in an initial Web browser session. The method also includes storing a record of an arrangement of the identified Web browser windows and tabs, and any necessary application state data in each window or tab, in connection with the end user in connection with the CRM application. Finally, the method includes subsequently detecting the end user establishing a new Web browser session with the CRM application and automatically spawning the different Web browser windows and tabs or presenting the user with a list of one or more work paths previously stored in connection with the arrangement specified in the record for the end user.

In one aspect of the embodiment, the record further includes a reference to different records of a database presented in selected ones of the identified Web browser windows and tabs such that during automatic spawning, the different records are retrieved and presented in the selected ones of the identified Web browser windows and tabs. In another aspect of the embodiment, the record further includes a list of identified work paths, each specifying a window and one or more tabs opened in the window, such that different ones of the Web browser windows and corresponding tabs specified in the record for the end user are automatically spawned as specified by one of the work paths selected by the end user in the list. In yet another aspect of the embodiment, the record further includes state information for the tabs, for instance a scroll position or data input provided in one or more user interface controls present in one or more of the tabs. In this way, the state information is restored in the tabs as part of the automatic spawning.

In even yet another aspect of the embodiment, the Web browser of the initial Web browser session is presented in a desktop computer and the new Web browser session is established through a mobile device, or the Web browser of the initial Web browser session is presented in a mobile device and the new Web browser session is established through a desktop computer.

In another embodiment of the invention, a Web driven application data processing system is configured for persistently tracking a work space arrangement of a CRM application through a Web browser. The system includes a host computing system that includes one or more computers each with memory and at least one processor. The system also includes a CRM application executing in the host computing system and providing access to CRM data in a coupled database to requesting end users over a computer communications network. The system even further includes a Web server serving to different Web browsers of the end users different Web pages each set of the different Web pages being reflective of a workspace for a corresponding one of the end users. Finally, the system includes a work space persistence management module coupled to the CRM application.

The module includes program code that when executed in the memory of the host computing system is enabled to identify different Web browser windows and tabs spawned in a Web browser in connection with an end user interacting with the CRM application through the Web browser in an initial Web browser session. The program code also is enabled to store a record of an arrangement of the identified Web browser windows and tabs in connection with the end user in connection with the CRM application. Finally, the program code is enabled to subsequently detect the end user establishing a new Web browser session with the CRM application, and to automatically spawn the different Web browser windows and tabs stored in the arrangement specified in the record for the end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for persistently tracking a work space arrangement of a CRM application through a Web browser;

FIG. 2 is a schematic illustration of a Web driven application data processing system configured for persistently tracking a work space arrangement of a CRM application through a Web browser; and,

FIG. 3 is a flow chart illustrating a process for persistently tracking a work space arrangement of a CRM application through a Web browser.

### DETAILED DESCRIPTION OF THE INVENTION

Embodiments of the invention provide for the persistent tracking of a work space arrangement of a CRM application through a Web browser. In accordance with an embodiment of the invention, a CRM application can be presented through a Web browser in which the user interface for the CRM application includes multiple different Web pages, and multiple different tabs presenting one or more of the different Web pages. An end user can authenticate into the CRM application through one of the different Web pages. Thereafter, in response to a request by the end user, an arrangement of different Web browser windows and tabs opened in connection with the end user utilizing the CRM application can be identified and recorded in a record of the CRM application associated with the end user. Later, as the CRM application detects the end user establishing a new Web browser session with the CRM application, the different Web browser windows and tabs stored in the arrangement specified in the record for the end user are spawned in the Web browser so as to restore the previously persisted arrangement of the work space of the CRM application.

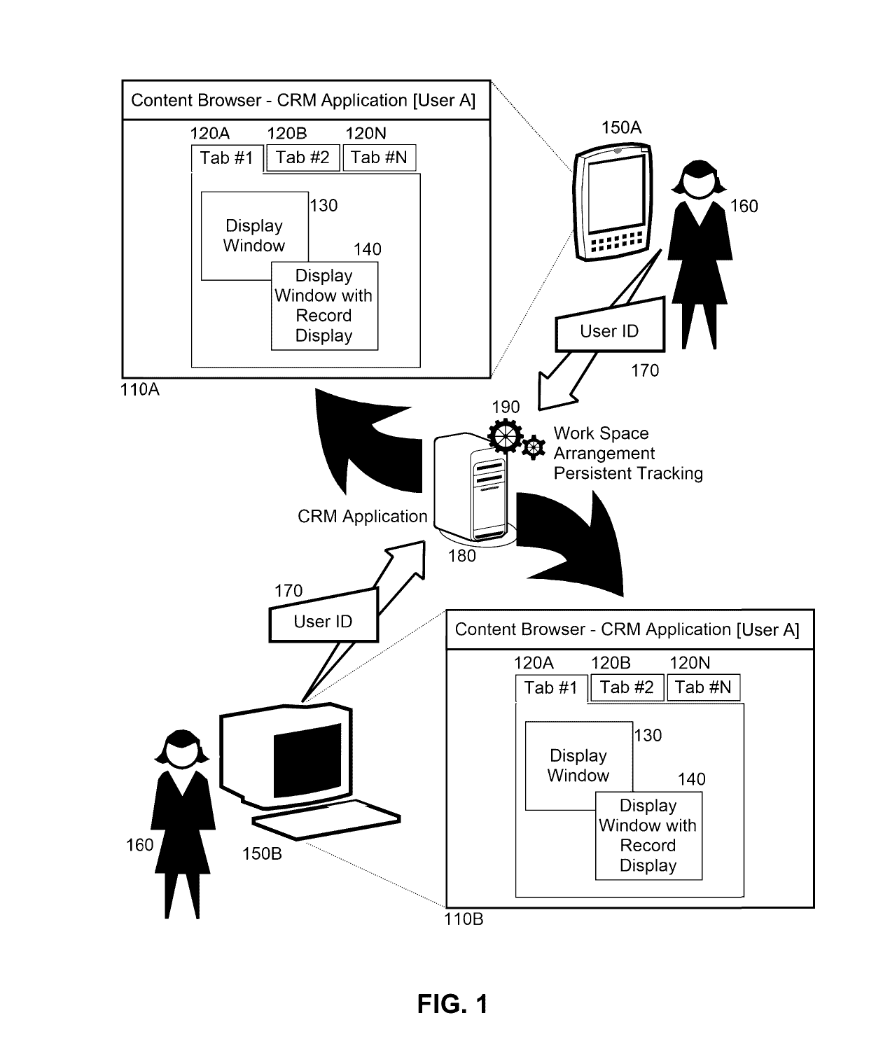

In further illustration, FIG. 1 pictorially shows a process for persistently tracking a work space arrangement of a CRM application through a Web browser. As shown in FIG. 1, an end user 160 provides authenticating data 170 to a CRM application 180 through a user interface presented in a Web browser 110A of a computing device 150A, such as a desktop computer or mobile device. The user interface includes different tabs 120A, 120B, 120N of different Web pages each with different controls disposed therein. The user interface further may include different windows 130, 140 with our without data retrieved from the records of a database of the CRM application 180. In the course of interacting with the CRM application 180, the end user 160 arranges the work space of the CRM application 180 to include a particular arrangement of the tabs 120A, 120B, 120N and windows 130, 140. As such, the end user 160 directs work space arrangement persistence tracking logic 190 to persist a record of the arrangement in the CRM application 180 in connection with the end user 160.

Optionally, a state of each of the tabs 120A, 120B, 120N and windows 130, 140 can be recorded, for example, a particular ordering of the tabs 120A, 120B, 120N in the windows 130, 140, or a scroll-state, e.g. a vertical and horizontal position in each of the tabs 120A, 120B, 120N and windows 130, 140, or data input provided in one or more user interface controls of the tabs 120A, 120B, 120N. As another option, a user-specific site map (not shown) of the CRM application 180 can be recorded. The user-specific site map can provide for different nodes representative of the different windows 130, 140, and different sub-nodes of the nodes representative of one or more of the tabs 120A, 120B, 120N present in the windows 130, 140. Each of the different nodes can be referred to as a work path and included in a list of recorded work paths. Responsive to the selection in the list of one of the different nodes corresponding to a particular work path, the corresponding one of the windows 130, 140 and associated tabs 120A, 120B, 120N can be opened and the previously recorded state for the corresponding one of the windows 130, 140 and associated tabs 120A, 120B, 120N restored.

Once the record has been persisted, the end user 160 provides authenticating data 170 to the CRM application 180 through a user interface presented in a Web browser 110B of a different computing device 150B, such as a desktop computer or mobile device. Work space arrangement persistence tracking logic 190 detects that the end user 160 had previously persisted the arrangement in the CRM application 180. Consequently, work space arrangement persistence tracking logic 190 directs the Web browser 110B of the computing device 150B to spawn the tabs 120A, 120B, 120N and windows 130, 140 of the arrangement as previously arranged by the end user 160 using the Web browser 110A in the computing device 150A. Optionally, the work space arrangement persistence tracking logic 190 also can retrieve relevant data from records of the database for the CRM application 180 as indicated by the persisted arrangement and as previously presented in a display window 140 in the Web browser 110A. As even a further option, the work space arrangement persistence tracking logic 190 also can retrieve a previously recorded state of the persisted arrangement as previously presented in the display window 140. The previously recorded state can include a prior scroll position, an ordering of the tabs 120A, 120B, 120N in the windows 130, 140 and data input provided in one or more user interface controls of the tabs 120A, 120B, 120N.

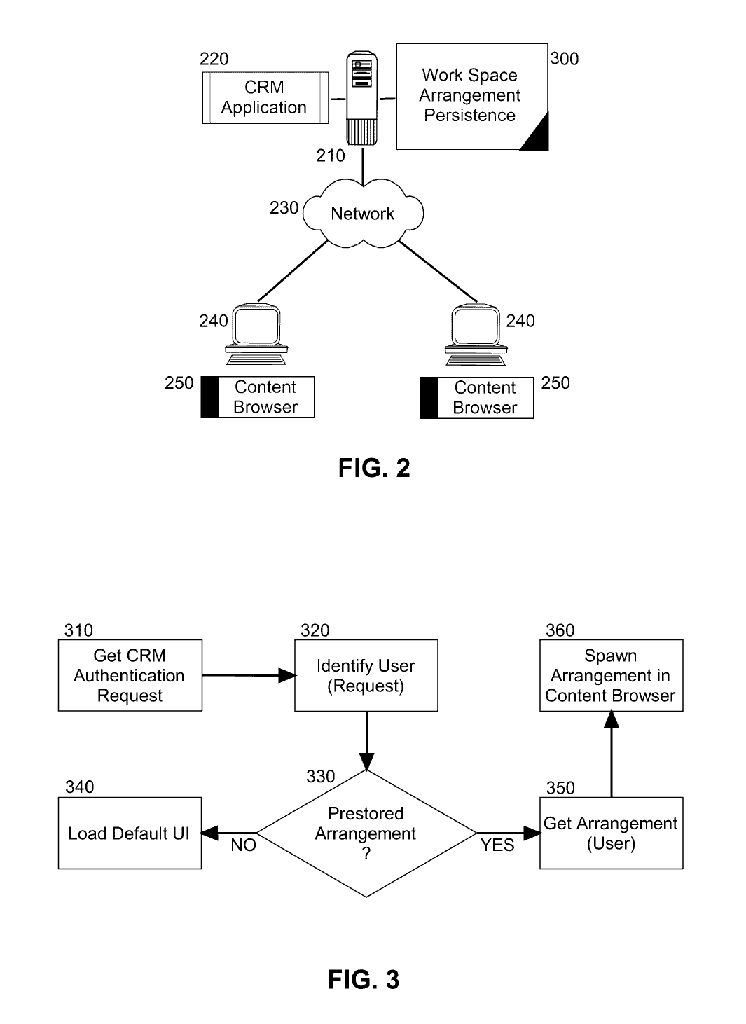

The process described in connection with FIG. 1 can be implemented in a CRM data processing system. In yet further illustration, FIG. 2 schematically illustrates a Web driven application data processing system configured for persistently tracking a work space arrangement of a CRM application through a Web browser. The system includes a host computing system 210 that includes one or more computers each with memory and at least one processor. The host computing system 210 supports the execution of a CRM application 220 providing a Web based user interface thereto presented to different end users in different content browsers 250 of different computing devices 240 over computer communications network 230.

Of note, a work space arrangement persistence module 300 is coupled to the CRM application 220. The module 300 includes program code enabled upon execution in the memory of the host computing system 210 to identify for a specific end user an arrangement in a respective one of the content browsers 250 of different tabs and different windows of the user interface to the CRM application 220. The module 300 optionally includes program code enabled upon execution in the memory of the host computing system 210 to recall one or more work paths for inclusion in a list of work paths, responsive to the selection of which the program code of the module 300 is enabled to recall and arrange one or more of the tabs of one or more windows previously hierarchically related to one another in a user specific site map. Further, the program code of the module 300 optionally is configured to permit the addition to or removal from the list of work paths of one or more of the work paths by the end user, or by an administrator of the CRM application 220.

Additionally, the program code is enabled to identify data from the database of the CRM application 220 retrieved and presented in one or more of the windows of the user interface in the respective one of the content browsers 250. The program code yet further is enabled to persist the arrangement and any indication of retrieved records in connection with the end user. Subsequently, in response to the end user establishing a new session with the CRM application 220, the arrangement and any indication of records is retrieved from storage and the respective one of the content browsers 250 is directed to spawn the tabs and windows of the arrangement and to populate one or more of the windows with the data of the records.

In even yet further illustration of the operation of the work space arrangement persistence module 300, FIG. 3 is a flow chart illustrating a process for persistently tracking a work space arrangement of a CRM application through a Web browser. Beginning in block 310, a CRM authentication request for the CRM application is received from a Web browser and in block 320, a user is identified by the request. In decision block 330, it is determined if an arrangement of tabs and windows for a Web based user interface for the CRM application had been previously persisted by the identified end user. If not, in block 340 a default arrangement of tabs and windows can be directed for presentation in the Web browser. Otherwise, in block 350, a previously persisted arrangement of tabs and windows is retrieved from the CRM application for the identified end user. Finally, in block 360, the Web browser is directed by the CRM application to spawn an arrangement of tabs and windows consistent with those of the persisted arrangement.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for persistently tracking work space arrangement of a customer relationship management (CRM) application through a Web browser, the method comprising:
identifying different Web browser windows and tabs spawned in the Web browser connection with an end user interacting with a CRM application through the Web browser in an initial Web browser session;
storing a record of an arrangement of the identified Web browser windows and tabs in connection with the end user in connection with the CRM application;
subsequently detecting the end user establishing a new Web browser session with the CRM application; and,
automatically spawning the different Web browser windows and tabs stored in the arrangement specified in the record for the end user.

2. The method of claim 1, wherein the record further includes a reference to different records of a database presented in selected ones of the identified Web browser windows and tabs such that during automatic spawning, the different records are retrieved and presented in the selected ones of the identified Web browser windows and tabs.

3. The method of claim 1, wherein the record further includes a list of identified work paths, each of the work paths comprising a window and one or more tabs opened in the window, and wherein different ones of the Web browser windows and corresponding tabs specified in the record for the end user are automatically spawned as specified by one of the work paths selected by the end user in the list.

4. The method of claim 1, wherein the record further includes state information for the tabs, the state information comprising a scroll position and data input provided in one or more user interface controls present in one or more of the tabs, and wherein the state information is restored in the tabs as part of the automatic spawning.

5. The method of claim 1, wherein the Web browser of the initial Web browser session is presented in a desktop computer and the new Web browser session is established through a mobile device.

6. The method of claim 1, wherein the Web browser of the initial Web browser session is presented in a mobile device and the new Web browser session is established through a desktop computer.

7. A Web driven application data processing system configured for persistently tracking a work space arrangement of a customer relationship management (CRM) application through a Web browser, the system comprising:
a host computing system comprising one or more computers each with memory and at least one processor;
a CRM application executing in the host computing system and providing access to CRM data in a coupled database to requesting end users over a computer communications network;
a Web server serving to different Web browsers of the end users different Web pages each set of the different Web pages being reflective of a workspace for a corresponding one of the end users; and,
a work space persistence management module coupled to the CRM application, the module comprising program code that when executed in the memory of the host computing system is enabled to identify different Web browser windows and tabs spawned in a Web browser in connection with an end user interacting with the CRM application through the Web browser in an initial Web browser session, to store a record of an arrangement of the identified Web browser windows and tabs in connection with the end user in connection with the CRM application, to subsequently detect the end user establishing a new Web browser session with the CRM application, and to automatically spawn the different Web browser windows and tabs stored in the arrangement specified in the record for the end user.

8. The system of claim 7, wherein the record further includes a reference to different records of the database presented in selected ones of the identified Web browser windows and tabs such that during automatic spawning, the different records are retrieved and presented in the selected ones of the identified Web browser windows and tabs.

9. The system of claim 7, wherein the record further includes a list of identified work paths, each of the work paths comprising a window and one or more tabs opened in the window, and wherein different ones of the Web browser windows and corresponding tabs specified in the record for the end user are automatically spawned as specified by one of the work paths selected by the end user in the list.

10. The system of claim 7, wherein the record further includes state information for the tabs, the state information comprising a scroll position and data input provided in one or more user interface controls present in one or more of the tabs, and wherein the state information is restored in the tabs as part of the automatic spawning.

11. The system of claim 7, wherein the Web browser of the initial Web browser session is presented in a desktop computer and the new Web browser session is established through a mobile device.

12. The system of claim 7, wherein the Web browser of the initial Web browser session is presented in a mobile device and the new Web browser session is established through a desktop computer.

13. A computer program product for persistently tracking work space arrangement of a customer relationship management (CRM) application through a Web browser, the computer program product comprising a computer readable storage medium having program instructions embodied therewith, the program instructions executable by a device to cause the device to perform a method comprising:
identifying different Web browser windows and tabs spawned in the Web browser connection with an end user interacting with a CRM application through the Web browser in an initial Web browser session;
storing a record of an arrangement of the identified Web browser windows and tabs in connection with the end user in connection with the CRM application;
subsequently detecting the end user establishing a new Web browser session with the CRM application; and,
automatically spawning the different Web browser windows and tabs stored in the arrangement specified in the record for the end user.

14. The computer program product of claim 13, wherein the record further includes a reference to different records of a database presented in selected ones of the identified Web browser windows and tabs such that during automatic spawning, the different records are retrieved and presented in the selected ones of the identified Web browser windows and tabs.

15. The computer program product of claim 13, wherein the record further includes a list of identified work paths, each of the work paths comprising a window and one or more tabs opened in the window, and wherein different ones of the Web browser windows and corresponding tabs specified in the record for the end user are automatically spawned as specified by one of the work paths selected by the end user in the list.

16. The computer program product of claim 13, wherein the record further includes state information for the tabs, the state information comprising a scroll position and data input provided in one or more user interface controls present in one or more of the tabs, and wherein the state information is restored in the tabs as part of the automatic spawning.

17. The computer program product of claim 13, wherein the Web browser of the initial Web browser session is presented in a desktop computer and the new Web browser session is established through a mobile device.

18. The computer program product of claim 13, wherein the Web browser of the initial Web browser session is presented in a mobile device and the new Web browser session is established through a desktop computer.
